(19) United States
(12) Patent Application Publication
(10) Pub. No.: US 2008/0201238 A1
(43) Pub. Date: Aug. 21, 2008

(54) Premium SMS billing method

(75) Inventors: Joseph J. Sulmar, Cambridge, MA (US); Andrew Egendorf, Lincoln, MA (US)

Correspondence Address: Hogan & Hartson L.L.P., 875 Third Avenue, New York, NY, 10022, US

(73) Assignee: Pilgrim Telephone, Inc.

(21) Appl. No.: 12/148,848

(22) Filed: Apr. 23, 2008

Related U.S. Application Data
(62) Division of application No. 11/029,210, filed on Jan. 3, 2005.

(51) Int. Cl. G06Q 30/00; H04Q 7/20

(52) U.S. Cl. 705/26; 455/466

(57) ABSTRACT

A method of billing for products and services wherein a user makes a voice call to a telephone number from a mobile telephone, interacts with a human or computer operator to learn about audio-text products and services offered by a vendor, and then agrees verbally or by pressing one or more DTMF keys on the user's mobile telephone's keypad to have the charge for the purchase placed on the user's mobile telephone bill. The service is then provided while the call still is connected, and after the call is terminated, an MT-PSMS message is sent to the user to place the charge on the user's mobile telephone bill.

### BACKGROUND OF THE INVENTION

The present invention relates to a method of billing for products and services purchased over a mobile telephone network utilizing the Premium Short Message Service (“PSMS”) billing platform.

The present invention relates to a new method of utilizing the PSMS billing platform, one which utilizes both the voice channel and the control channel of a mobile telephone network. All present systems utilize only the control channel. By utilizing the voice channel rather than solely the control channel, purchases over a mobile telephone network can be made more conveniently, more easily, more quickly, and more accurately.

Applicant hereby incorporates by reference in its entirety Silver et al., U.S. Pat. No. 5,146,491, issued Sep. 8, 1992.

Silver et al. describes a telephonic billing method whereby a user initiates a telephone call to a toll-free number, agrees during the call to purchase a product or service, and agrees to convert the call to a paid call either during or after the initial call in order to pay for the purchase. The effect of the overall transaction is that the billing platform of the telephone system is used to pay for products or services purchased during the call by placing the charges for the purchase on the telephone bill of the purchaser. In claim 11 of Silver et al., for example, the vendor calls the purchaser collect after the termination of the initial call as the method of putting the charge on the telephone bill of the purchaser. The method of Silver et al. utilizes the voice channel in order to authorize the conversion of the initially-free call to a paid call for the purposes of billing for products or services purchased during the call.

Short Message Service (“SMS”) messaging is a textual communications method offered by mobile telephone service providers as an alternative to voice communications. SMS messaging can be preferable to voice communications, particularly when the information to be conveyed is short, or requires silence or privacy. SMS messages are addressed to the recipient by a telephone number-type network address, as are conventional voice communications. Current SMS systems utilize the same channels in a mobile telephone network as are used for controlling voice call messages (the “control channel”), rather than the channels that are used for the voice messages themselves (the “voice channel”). SMS messaging was introduced in 1992.

Premium SMS (“PSMS”) refers to a method of charging users a premium fee for sending or receiving SMS messages. In the United States, the user initiates the charging by sending an SMS message to a 5-digit “short-code” address, rather than to a full telephone number address as is used for other SMS messages. If the charge is made to a recipient of a PSMS message, the message may be referred to as being “MT-PSMS”, for “mobile-terminated premium SMS”. If the charge is made to a sender of a PSMS message, the message may be referred to as being “MO-PSMS”, for “mobile-originated premium SMS”. Examples of MT-PSMS include mobile telephone users paying a premium price to obtain messages concerning traffic information, weather, or sports scores. Charges for these PSMS messages appear on the user's mobile telephone bill, or, in the case of pre-paid mobile users, are deducted from the pre-paid balance. Originally, PSMS billing was used only for billing for the content contained in the SMS message itself, although more recently the PSMS billing platform has been used to bill for other products and services. MT-PSMS has been available internationally since about 1998, but became available in the United States only in the last year or so. MO-PSMS also is available internationally, but applicant is unaware of its use in the United States.

“Billing On Behalf Of” or “BOBO” is permitted by certain mobile service providers, whereby the PSMS billing platform can be used as a billing platform for the sale of products and services other than the text and data content within the body of the SMS messages involved in creating the bill. For example, a mobile user now can purchase movie tickets using PSMS if her mobile telephone service provider has arranged BOBO with a ticket vendor to sell the tickets over the mobile network. The cost of the tickets would be billed as a PSMS message, and placed on the mobile user's mobile telephone bill, or deducted from a pre-paid balance, and the mobile service provider would remit a portion of the collected amount to the ticket vendor, keeping the difference as its fee for providing billing for the ticket-selling service.

All PSMS billing presently requires that the agreement between the user and the vendor to place charges on the user's mobile telephone bill be made according to an “Opt-In Protocol” approved by the mobile service provider. The Opt-In Protocol takes place after the user has decided to purchase something from a previously-offered advertisement, promotion, or menu of products and services with associated prices. All presently-used Opt-In Protocols require that a series of text messages be sent from the user to the vendor and from the vendor to the user. All of these messages are transmitted between the parties using only the control channel of the mobile telephone network. A typical Opt-In Protocol using only the control channel is as follows.

User makes an initial request by sending a standard SMS text message to an advertised short-code. Example: user sends text “Chat” to short-code 44556.

Vendor makes a confirmation request by sending a standard SMS text message back to user at the mobile telephone number from which the user sent the message “Chat”. Example: vendor sends text “Reply with ‘I AGREE’ if you would like to purchase 10 minutes of access for only $1.00.” to telephone number 781-634-8055.

User confirms her desire to make a purchase and authorizes billing to be placed on the bill of her mobile telephone by sending a standard SMS text message to the same short-code to which the initial request was sent. Example: user sends text “I AGREE” to short-code 44556.

If the user purchases an audio-text product or service which she desires to use immediately, she must terminate or suspend the text session used for the Opt-In Protocol and make a voice call to access the purchased product or service.

### SUMMARY OF THE INVENTION

The main object of the present invention is to provide a billing method which allows a user of a mobile telephone to dial a telephone number to place a voice call to a vendor of products or services and then, at the user's request during the call, agree by verbal and/or DTMF input (i.e., over the voice channel of the mobile telephone network) to purchase a product or service and be charged for the purchase by allowing the amount of the charge to be put on the user's mobile telephone bill by being sent an MT-PSMS message.

Another object of the present invention is to allow the billing to be accomplished by the use of an MO-PSMS message.

Still other objects of the present invention include allowing the user to purchase any product or service, to have the product or service delivered or performed either during or after the call in which the purchase is made, to have the product or service delivered or performed either before or after the charge for it is made by the sending of the MT-PSMS or MO-PSMS message, and to have the MT-PSMS or MO-PSMS message itself sent either during or after the call in which the purchase is made.

In a preferred embodiment, the user makes a voice call to a telephone number from a mobile telephone, interacts with a human or computer operator to learn about audio-text products and services offered, and then agrees verbally or by pressing one or more DTMF keys on the user's mobile telephone's keypad to have the charge for the purchase placed on the user's mobile telephone bill. The service is then provided while the call still is connected, and after the call is terminated, an MT-PSMS message is sent to the user to place the charge on the user's mobile telephone bill.

Although in the preferred embodiment the audio-text product or service is delivered while the call is connected, it is clear from the description of the preferred embodiment that audio text products could be sold in other forms, for example, selling a token usable from a telephone or computer to access audio-text services and selling a PIN usable from a telephone or computer to access audio-text services. In these situations, the embodiment of the product sold by the method of the present invention is the token or PIN, and it is the use of the token or PIN which allows the user to access audio-text products and services at a later time and from any telephone instrument or telephony-capable computer.

It also is clear from the description of the preferred embodiment that any product or service could be sold by this method, that the product or service could be delivered or performed either during or after the call, that the product or service could be delivered either before or after the charge is made, and that the charge could be made either during or after the call and by using either an MT-PSMS or an MO-PSMS message.

Examples of other telecommunications products which could be sold by the method of the present invention include the sale of pre-paid time for cellular telephones, and pre-paid calling cards.

Examples of other non-telecommunications products which could be sold by the method of the present invention include sale of “fast-food” at counters and drive-up windows, and payment of parking charges at meters and parking lots.

The method of the present invention differs from existing methods of using the PSMS billing platform in that in existing methods, the agreement between the user and the vendor to place the charges on the user's mobile telephone bill by means of a PSMS message must be accomplished by a series of text messages. In the case of the purchase of an audio-text product or service, a separate voice call must be made by the user subsequent to the text message Opt-In Protocol to obtain the audio-text product or service.

The existing method of sending text messages and then placing a separate voice call is much more inconvenient, much more difficult, much slower, and much more prone to error, than is sending verbal or DTMF input and then receiving the purchased audio-text product or service on the same voice call. The method according to the present invention accomplishes the objective of allowing both the performing of the Opt-In Protocol and the enjoyment of the audio-text product or service to be accomplished with one voice call from a mobile telephone. The Opt-In Protocol takes place after the user has decided to purchase something from a previously-offered menu of products and services with associated prices. An example Opt-In Protocol according to the method of the present invention is as follows.

User makes an initial request by responding affirmatively to a voice prompt on an Interactive Voice Response (“IVR”) system. Such affirmative response may take the form of verbal or DTMF input during the call. Example: IVR plays pre-recorded message, “Press 1 now if you would like to pay for this service by having it billed to your wireless telephone bill.”. User presses “1” on her mobile telephone's keypad.

Vendor makes a confirmation request verbally or by audible cue during the call. Example: IVR plays pre-recorded message, “Press 1 to confirm that you are over 18 and that you agree to purchase 10 minutes of access for $1.00.”.

User confirms her desire to make the purchase and to charge the cost to her wireless bill by verbal response or by DTMF input during the call. Example:

User presses “1” on her mobile telephone's keypad.

Because the user initially placed a voice call, after the Opt-In Protocol shown in paragraphs 0023-0025 has been completed, the user immediately can begin using the purchased 10 minutes of access, avoiding the necessity of terminating the text-mode communication and placing a subsequent voice call, as would be the situation under Opt-In Protocols of prior art methods.

These and other objects and features of the invention will become more apparent from the following detailed description taken with the attached drawings.

### BRIEF DESCRIPTION OF THE DRAWINGS

FIG. 1 is a block diagram of a system for carrying out the method according to the present invention.

FIG. 2 is a flow chart of an overview of a general method according to the present invention.

FIG. 3 is a flow chart of a preferred embodiment of the method according to the present invention.

### DETAILED DESCRIPTION OF A PREFERRED EMBODIMENT

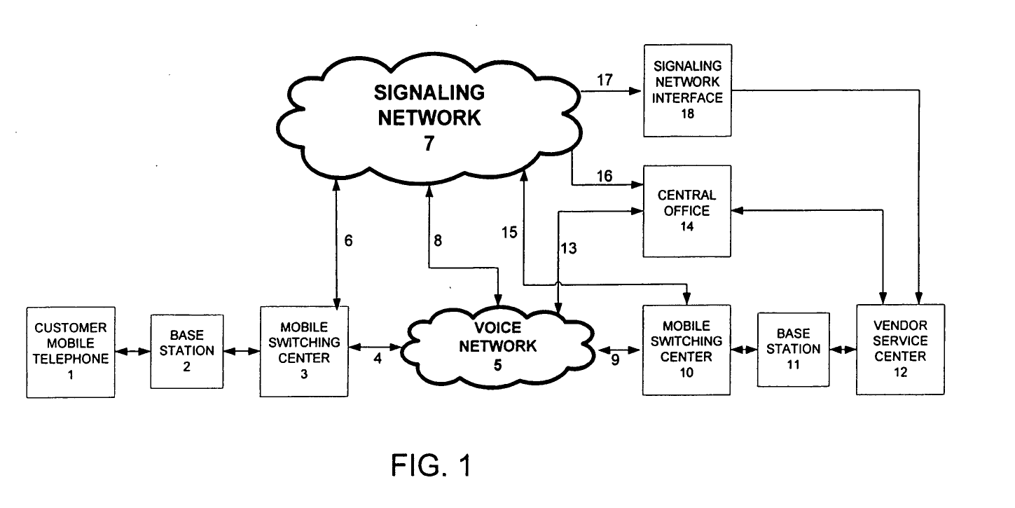

FIG. 1 is a block diagram of a system for carrying out the method according to the present invention. For clarity, FIG. 1 shows only that portion of the system relating to messages being sent from a user's mobile telephone to a vendor's service center. Mobile telephone (“MT”) 1 transmits voice and text calls from base station (“BS”) 2 which in turn transmits to mobile switching center (“MSC”) 3. At MSC 3, calls originating from MT 1 are separated into two distinct transmissions, and are sent over two distinct transmission links, voice trunk (“VT”) 4 and signaling link (“SL”) 6.

VT 4 transmits the voice portion of calls originating at MT 1 to voice network (“VN”) 5. SL 6 transmits both call control information and SMS messages to signaling network (“SN”) 7. Within SN 7 are located both the Short Message Service Center (“SMSC”) and the Home Location Register (“HLR”). When an SMS message arrives at the SMSC, the SMSC queries the HLR to determine if the intended recipient of the SMS message is active on the network and capable at that moment of the receiving the message. If so, the message is delivered; if not, the message can be stored in the SMSC until a later time when either it is delivered to the recipient or a failure message is returned to the sender. VN 5 and SN 7 are conceptually distinct, but not necessarily physically distinct, as indicated by interconnections 8.

VN 5 determines whether the recipient of the call is a land-line telephone or a mobile telephone, and transmits the voice portion of calls originating at MT 1 accordingly. If a mobile telephone number, it transmits them over VT 9 to MSC 10, from which they are sent to BS 11 and then to the vendor's service center (“VSC”) 12. If a land-line telephone number, it transmits them over VT 13 to central office (“CO”) 14, from which they are sent over VT 15 to VSC 12.

SN 7 sends call control signals over one or more of SLs 15, 16, and 17, depending upon the type of call and the recipient. For example, if the call is a voice call from MT 1 to a land-line telephone in VSC 12, control signals will be sent over SL 16 through CO 14. Control signals for mobile telephone recipients are sent over SL 15 to MSC 10. If a text message is sent from MT 1, it passes from SN 7 over SL 17 to the signaling network interface (“SNI”) 18 to VSC 12.

VSC 12 contains the vendor's land-line telephones, mobile telephones, and data processing center capable of receiving text messages sent through SNI 18. An example of the “voice channel” shown in FIG. 1 is the pathway 1-2-3-4-5-9-10-11-12. An example of the “control channel” shown for the same call is the pathway 1-2-3-6-7-15-10-11-12. A PSMS message sent to a short-code address would follow pathway 1-2-3-6-7-17-18-12.

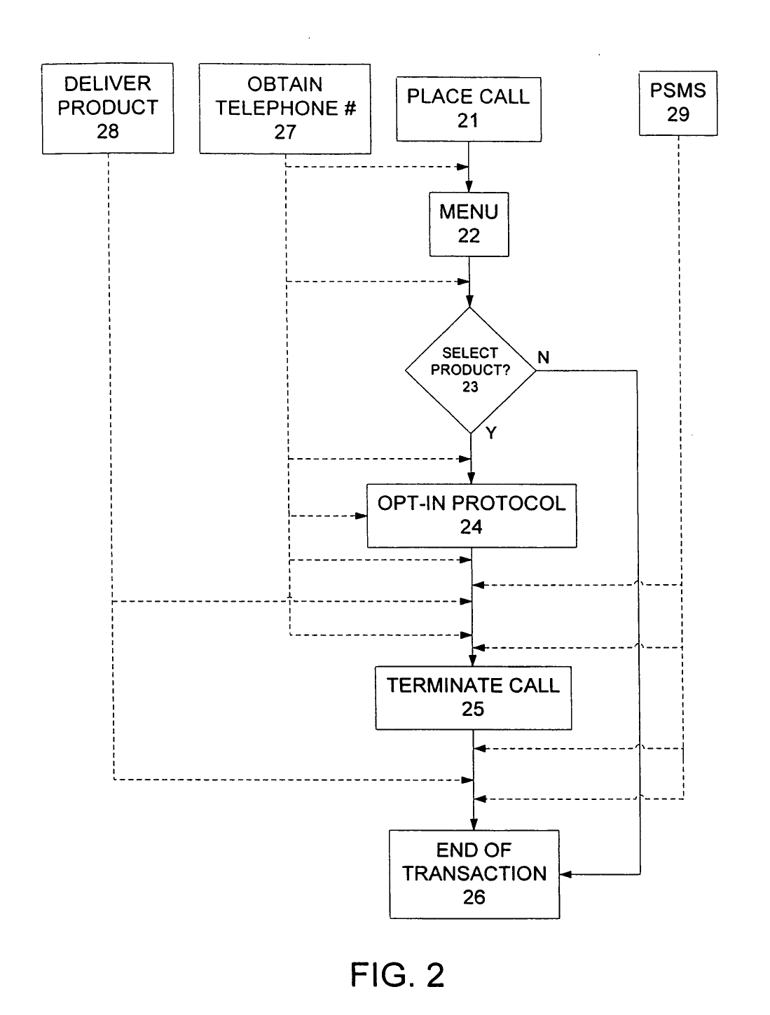

FIG. 2 shows an overview of a general method according to the present invention. In step 21, the user places a voice call over a mobile telephone network to the vendor. This call may be made in a manner which is free to the user (except possibly for so-called “air-time”), for example by use of an “800”, “888”, or local number, or may be made in a manner which is normally charged to the user, for example by use of a long-distance toll call or a “976” number, or may be made in a manner which generally is considered to be a pay call, but which, in fact, is not charged for in the customary manner, for example a “900” call for which the carrier of the call either does not bill at all, or bills only for the air-time. In step 22, the vendor presents the user with a menu of products and services. These steps are done typically by IVR, but may, of course, be done by interaction with a human operator. In step 23, the user either terminates the call, and ends the transaction at 26, or selects a product or service to purchase. In step 24, the user agrees (i.e., “opts-in”) over the voice channel of the mobile telephone network to purchase the selected product or service and to have the cost thereof charged to her mobile telephone number. This is accomplished by the exchange of verbal and/or DTMF messages in accordance with the Opt-In Protocol of the method of the present invention (an example of which is given at paragraphs 0023-0025, above. In step 25, the user terminates the call.

Step 27 is the step by which the vendor obtains the mobile telephone number to charge. This may occur, as indicated by the dotted lines in FIG. 1, in many places between steps 1 and the end of the transaction 26. If the caller calls the vendor in a manner which delivers to the vendor the Automatic Number Identification (“ANI”) of the calling telephone number, or the Mobile Identification Number (“MIN”) of the mobile telephone instrument, or identifies the calling telephone number by Caller ID, then step 27 occurs between steps 21 and 22. Otherwise, the vendor can request the user to input her mobile telephone number at any time during the call, although this typically would be done only after the user had agreed to purchase, in other words, during step 24 or between steps 24 and 25. The user may input her mobile telephone number by verbal or DTMF input.

Step 28 is the step where the vendor delivers the product or service to the user. This step occurs after the user has agreed to purchase in step 24, and, as indicated by the dotted lines in FIG. 1, may take place either before or after the call is terminated in step 25, and either before or after the user is billed by PSMS in step 29.

Step 29 is the step where either the vendor sends the user an MT-PSMS message or the user sends the vendor an MO-PSMS message, in order to place the charges on the mobile telephone bill of the user. This step occurs after the user has agreed to purchase, and, as indicated by the dotted lines in FIG. 1, may take place either before or after the product is delivered to the user in step 28, and either before or after the call is terminated in step 25.

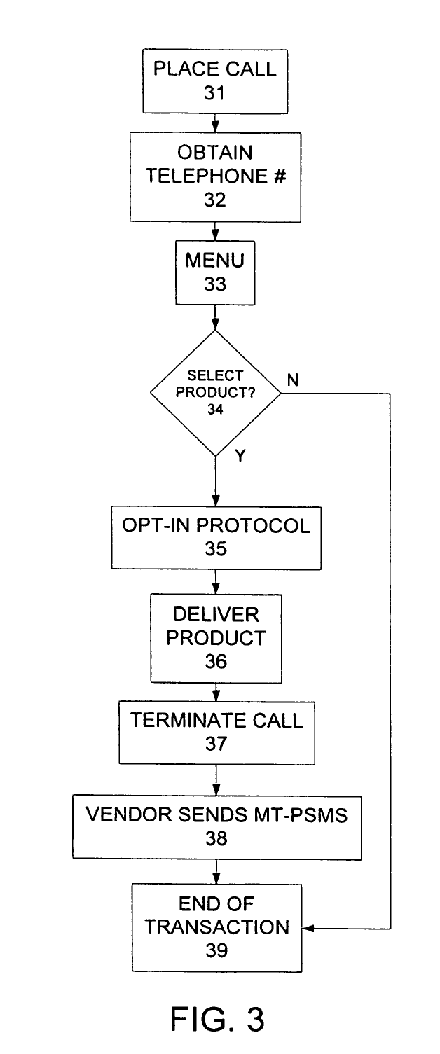

FIG. 3 shows the preferred embodiment of the method according to the present invention. All interactions between the user and the vendor are by IVR, with the user providing DTMF input. In Step 31, the user places a voice call over a mobile telephone network to the vendor by use of a toll-free (except possibly for air-time) number which delivers ANI or MIN to the vendor, for example an “800” or “888” number, or a “900” number for which the carrier of the call does not bill at all or bills only for air-time. In step 32, the vendor receives the ANI or MIN of the calling mobile telephone number. In step 33, the vendor presents the user with a menu of audio-text products and services. In step 34, the user either terminates the call and ends the transaction at 39, or selects a product or service to purchase. In step 35, the user agrees over the voice channel of the mobile telephone network to purchase the selected product or service and to have the cost thereof charged to her mobile telephone number. This is accomplished by following a pre-established Opt-In Protocol. An example of such an Opt-In Protocol for a first-time purchaser is given at paragraphs 0023-0025. It is expected that even simpler Opt-In Protocols may be used for repeat purchasers. In step 36, the vendor delivers the audio-text product or service to the user by connecting the call to the selected product or service (e.g., by adding the user to an already-in-progress conference call on a subject selected from the menu before the agreement to purchase by the user). In step 37, the user terminates the call. In step 38, the vendor sends the user an MT-PSMS message in order to place the charges on her mobile telephone bill.

It will be appreciated that the instant specification and claims are set forth by way of illustration and not limitation, and that various modifications and changes may be made without departing from the spirit and scope of the present invention.

1-18. (canceled)

19. A method of billing for products and services comprising the steps by a vendor of products or services of:
a. providing a telephone number to enable a user of a mobile telephone network having a voice channel and a control channel to access a vendor of products or services by a voice call from a mobile telephone number;
b. during the call presenting the user with the option of purchasing at least one product or service at a stated purchase price from the vendor;
c. during the call obtaining the agreement of the user to purchase the at least one product or service and to pay therefor by having the stated purchase price billed to the mobile telephone number by an agreement procedure requiring the user to enter input over the voice channel;
d. obtaining the mobile telephone number; and
e. receiving an MO-PSMS message sent from the mobile telephone number over the control channel whereby the amount of the stated purchase price is charged to the mobile telephone number.

20. The method of claim 19, wherein the input by the user over the voice channel comprises at least one of verbal and DTMF inputs.

21. The method of claim 19, wherein the vendor obtains the mobile telephone number by using ANI or MIN, Caller ID, DTMF input by the user, or verbal input by the user.

22. The method of claim 20, wherein the vendor obtains the mobile telephone number by using ANI or MIN, Caller ID, DTMF input by the user, or verbal input by the user.

23. The method of claim 19, wherein the MO-PSMS message is received from the mobile telephone number during the telephone call.

24. The method of claim 20, wherein the MO-PSMS message is received from the mobile telephone number during the telephone call.

25. The method of claim 21, wherein the MO-PSMS message is received from the mobile telephone number during the telephone call.

26. The method of claim 22, wherein the MO-PSMS message is received from the mobile telephone number during the telephone call.

27. The method of claim 19, wherein the MO-PSMS message is received from the mobile telephone number after the telephone call.

28. The method of claim 20, wherein the MO-PSMS message is received from the mobile telephone number after the telephone call.

29. The method of claim 21, wherein the MO-PSMS message is received from the mobile telephone number after the telephone call.

30. The method of claim 22, wherein the MO-PSMS message is received from the mobile telephone number after the telephone call.

31. The method of any of claims 19-30, wherein the product or service is delivered before receiving the MO-PSMS message.

32. The method of any of claims 19-30, wherein the product or service is delivered after receiving the MO-PSMS message.

33. The method of any of claims 19-30, wherein the product or service is audio-text, a token usable from a telephone or computer to access audio-text services, or a PIN usable from a telephone or computer to access audio-text services.

34. The method of claim 31, wherein the product or service is audio-text, a token usable from a telephone or computer to access audio-text services, or a PIN usable from a telephone or computer to access audio-text services.

35. The method of claim 32, wherein the product or service is audio-text, a token usable from a telephone or computer to access audio-text services, or a PIN usable from a telephone or computer to access audio-text services.

36. A method of billing for products and services comprising the steps by a vendor of products or services of:
a. providing a toll-free telephone number to enable a user of a mobile telephone network having a voice channel and a control channel to access a vendor of products or services by a voice call from a mobile telephone number;
b. during the call presenting the user with the option of purchasing audio-text services from the vendor at a stated purchase price;
c. during the call obtaining the agreement of the user to purchase audio-text services and to pay therefor by having the stated purchase price billed to the mobile telephone number by an agreement procedure requiring the user to enter at least one of verbal and DTMF inputs over the voice channel;
d. obtaining the mobile telephone number by using ANI or MIN; and
e. receiving an MO-PSMS message sent from the mobile telephone number over the control channel whereby the amount of the stated purchase price is charged to the mobile telephone number.
